(19) United States
(12) Patent Application Publication
(10) Pub. No.: US 2006/0058073 A1
(43) Pub. Date: Mar. 16, 2006

(54) Portable cellular phone holder which has an electric charging ability

(76) Inventor: Duck-Young Kim, Seoul (KR)

Correspondence Address: GREENBLUM & BERNSTEIN, P.L.C., 1950 ROLAND CLARKE PLACE, RESTON, VA, 20191, US

(21) Appl. No.: 10/542,541

(22) PCT Filed: Jun. 30, 2004
(86) PCT No.: PCT/KR04/01594

§ 371 Date: Jul. 18, 2005

(30) Foreign Application Priority Data
Jan. 29, 2004 (KR) 10-2004-0005620
Apr. 29, 2004 (KR) 10-2004-0029989

(51) Int. Cl. H04B 1/38

(52) U.S. Cl. 455/573

(57) ABSTRACT

Disclosed herein is a portable cellular phone holder having an electric charging function. The portable cellular phone holder is provided with a terminal cap (30) to electrically connect a contact terminal (12a) of a cellular phone (10) to a charging terminal (25) of a charger part (20) provided in the cellular phone holder. Thus, when it is required to charge the cellular phone, the charging operation is easily carried out merely by attaching or detaching the terminal cap. Therefore, call interruption due to the exhaustion of a battery is prevented.

### TECHNICAL FIELD

The present invention relates, in general, to a portable cellular phone holder having an electric charging function and, more particularly, to a portable cellular phone holder having an electric charging function, which is compact in structure and allows a cellular phone to be easily charged.

### BACKGROUND ART

Recent cellular phones are designed such that a battery thereof is charged only by a charging device which is separately provided. However, the charged battery usually has a short life, so that it cannot be used for more than a day or two. Thus, when making a long call while being out or when making a long trip, such as an unexpected business trip, the battery may become discharge In this case, it is impossible to make a call using a cellular phone.

Therefore, when going out, a user must carry a standby battery, thus causing inconvenience to the user. Further, when making a trip, the user must also carry a battery charging device, thus causing inconvenience to the user.

Recently, the cellular phone has various multimedia functions, including a picture display function, a banking function, an MP3 player function, a gaming function, and other functions, so that it is possible to allow a user to access various services using only the cellular phone. However, when using these functions, the power of the battery is rapidly exhausted. In this case, the battery may become discharged in only one day, so that it is difficult to use all of the desired multimedia functions.

In order to solve the problems, Korean U.M. Registration No. 20-0307358 was proposed. According to this document, a solar cell which changes solar heat into electricity is attached to a portable cellular phone case. When a charging terminal of a main body of the case comes into contact with a charging terminal of a cellular phone, the cellular phone is charged by the solar cell.

However, the conventional cellular phone case has a drawback in that it is impossible to use solar heat when it is cloudy or it rains, so that practicality is poor due to dependence on environmental conditions.

In Korean U.M. Registration No. 20-0232603 there is disclosed a cellular phone holder having an electric charging function. The cellular phone holder is equipped with a battery outputting a predetermined voltage, thus being capable of charging a cellular phone. Further, the cellular phone holder is provided with a radio that receives AM/FM radio signals and an LD player that plays a laser disc (LD), thus having multimedia functions.

However, the conventional cellular phone holder has a problem in that it charges the cellular phone using an additional battery, so that an internal construction of the cellular phone holder is complicated, and the overall size and weight of the cellular phone holder are increased, thereby it is difficult to carry the cellular phone holder.

In order to solve the problems, the present invention is proposed. The object of this invention is to provide a portable cellular phone holder having an electric charging function, which is configured such that a terminal cap which serves to electrically connect a cellular phone to a charger part provided in the cellular phone holder is detachably attached to the cellular phone or the cellular phone holder, thus allowing a phone charging operation to be easily carried out, simplifying an internal construction of the cellular phone holder, and reducing weight or size of the cellular phone holder, therefore considerably enhancing portability.

### BRIEF DESCRIPTION OF THE DRAWINGS

FIG. 1 is a perspective view to show the construction of a portable cellular phone holder, according to the first embodiment of the present invention;

FIG. 2 is a view to show a cellular phone and the cellular phone holder when the charging operation is executed by the cellular phone holder of FIG. 1;

FIG. 3 is a view to show the cellular phone and the cellular phone holder of FIG. 1 when the charging operation is executed by a charging cable;

FIG. 4 is a block diagram to schematically show an internal construction of a charger part included in the cellular phone holder of FIG. 1;

FIG. 5 is a perspective view to show a construction of a portable cellular phone holder, according to the second embodiment of the present invention;

FIG. 6 is a view to show a cellular phone and the cellular phone holder when the charging Nation is executed by the cellular phone holder of FIG. 5; and

FIG. 7 is a view to show the cellular phone and the cellular phone holder of FIG. 5 when the charging operation is executed by a charging cable.

### DISCLOSURE

Technical Solution

In order to accomplish the above object, the present invention provides a portable cellular phone holder having an electric charging function, including a main body to receive a cellular phone having a phone contact terminal; a charger part provided at a predetermined position of the main body and having a charging terminal; and a terminal cap having a cap contact terminal which electrically connects the phone contact terminal to the charging terminal.

The charger part includes a charger contact terminal to be connected to an external charging jack

The terminal cap is selectively fitted into and connected to the phone contact terminal or the charger contact terminal.

The portable cellular phone holder further includes a closure cap to selectively cover the phone contact terminal or the charger contact terminal.

The main body may comprise a panel-type structure to support the cellular phone. Preferably, the charger part is integrated with the main body in a single structure.

Unlike the above-mentioned construction, the main body may comprise a case-type structure to receive the cellular phone and the charger part therein, with an opening formed on the main body at a position corresponding to the charger contact terminal

Preferably, the main body includes a cover sheet to open or close the opening.

Further, an LED may be provided on the charger part to display a charging state of the cellular phone.

The preferred embodiments of the present invention will be described in detail with reference to the accompanying drawings.

Best Mode

Reference should now be made to the drawings, in which the same reference numerals are used throughout the different drawings to designate the same or similar components.

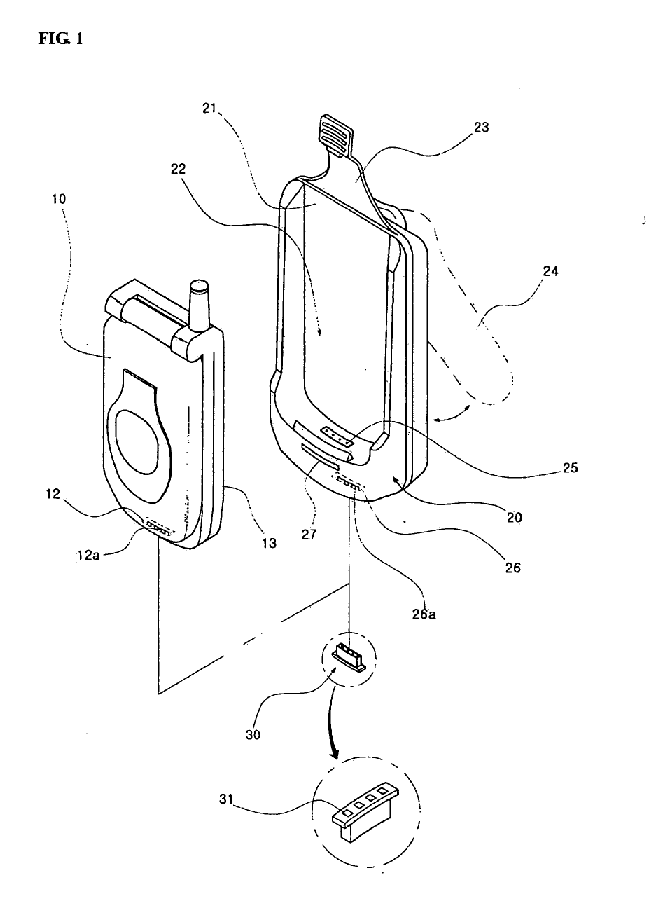

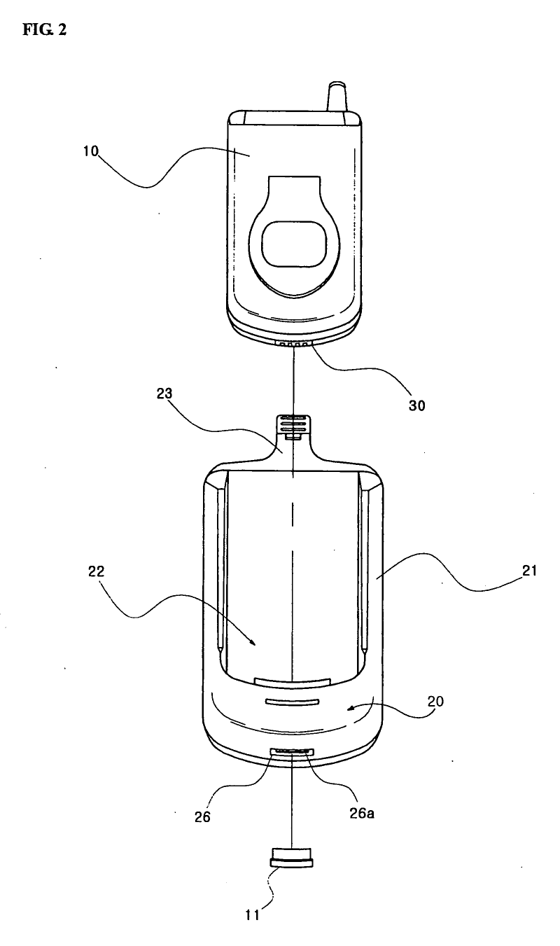

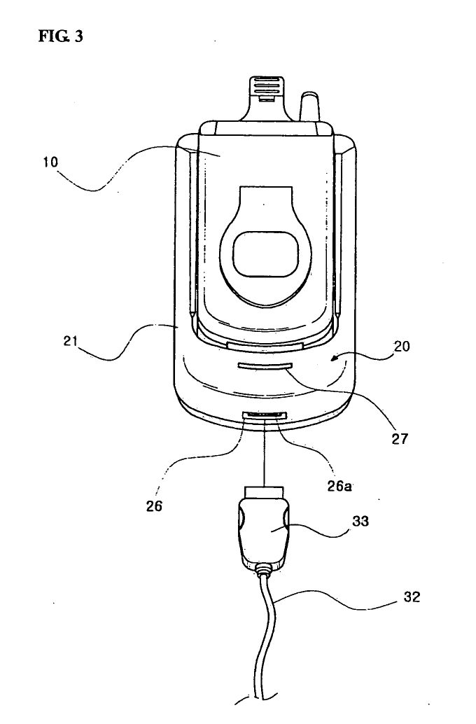

FIG. 1 is a perspective view to show a construction of a portable cellular phone holder, according to the first embodiment of the present invention. Further, FIG. 2 is a view to show a cellular phone which is charged by a previously charged charger part and FIG. 3 is a view to show the charger part and the cellular phone which are charged by an external charging cable.

Referring to FIGS. 1 to 3, the portable cellular phone holder of this invention includes a main body 21 to receive a cellular phone 10, a charger part 20 to charge the cellular phone 10 received in the main body 21, and a final cap 30 which electrically connects the cellular phone 10 to the charger part 20 to charge the cellular phone 10.

The main body 21 is fabricated in the form of a panel to support the cellular phone 10. A phone receiving part 22 is provided on a front of the main body 21 to receive the cellular phone 10. A holding means 23 is provided at an upper position on the main body 21 to hold the cellular phone 10 received in the phone receiving part 22.

Further, a clip 24 is mounted to a rear surface of the main body 21 to be fastened to a belt or the like, thus allowing a user to easily wear the cellular phone holder on his/her waist or elsewhere on his/her body.

The charger part 20 is integrally provided on a lower portion of the main body 21. A charging circuit or a rechargeable battery unit (not shown) are provided in the charger part 20.

Further, a charging terminal 25 is provided on an upper portion of the charger part 20 and is exposed to the outside. A recess 26 is provided on a lower portion of the charger part 20.

A charger contact terminal 26a is provided in the recess 26 to be electrically connected to the charging circuit and the rechargeable battery unit. Further, a charging jack 33 may be connected to the charger contact terminal 26a.

Thus, the charger contact terminal 26a provided on the lower portion of the charger part 20 is electrically connected to the charging terminal 25 provided on the upper portion of the charger part 20 via the charging circuit and the rechargeable battery unit.

The structure of the upper portion of the charger part 20 may vary according to the kind or shape of cellular phone to be received in the main body 21, as long as the cellular phone is in close contact with the upper portion of the charger part 20.

A light emitting diode (LED) 27 is provided on the front of the charger part 20 to allow a user to confirm the charging state, when the charger part 20 or the cellular phone 10 is charged using an external charging cable 32.

Similarly to conventional cellular phones, the cellular phone 10 has on a lower end thereof a phone contact terminal 12a , which is used to charge a battery 13 or transceive data. The phone contact terminal 12a is located in a recess 12.

Further, a closure cap 11 is detachably fitted into the recess 12 to prevent the phone contact terminal 12a from being exposed to the outside at normal times.

The terminal cap 30 adapted to this invention is made of a synthetic resin material, with a cap contact terminal 31 insert-formed in the terminal cap 30. The cap contact terminal 31 electrically connects the terminal cap 30 to the phone contact terminal 12a , the charging terminal 25, or the charger contact terminal 26a.

The terminal cap 30 is formed to be smoothly detachably fitted into the recess 12 of the cellular phone 10 or the recess 26 of the charger part 20, in a manner similar to the closure cap 11. When the cellular phone 10 is not charged, the terminal cap 30 is fitted into the recess 26 of the charger part 20.

When it is required to charge the cellular phone 10 using the cellular phone holder of this invention constructed as described above, as shown in FIG. 2, the terminal cap 30 is removed from the lower portion of the charger part 20 of the cellular phone holder. Subsequently, the terminal cap 30 is fitted into the recess 12 provided on the lower end of the cellular phone 10.

In such a state, when the cellular phone 10 having the terminal cap 30 is held in the phone receiving part 22 of the main body 21, the cap contact terminal 31 is connected to both the phone contact terminal 12a and the charging terminal 25 to form a closed circuit, thus charging the cellular phone 10.

Such a phone charging operation is executed until the charge level of the battery 13 of the cellular phone 10 becomes equal to the charge level of the rechargeable battery unit (not shown) provided in the charger part 20.

In order to prevent the loss of the closure cap 11 when charging the cellular phone 10, the closure cap 11 is removed from the recess 12 of the cellular phone 10 and then fitted into the recess 26 of the charger part 20. Meanwhile, when the phone charging operation has been completed, the closure cap 11 is fitted into the recess 12 of the cellular phone 10 and the terminal cap 30 is fitted into the recess 26 of the charger part 20, thus preventing the loss of the terminal cap 30 and the closure cap 11.

As shown in FIG. 3, the cellular phone holder of this invention allows the charger part 20 or the cellular phone 10 to be caged using the external charging cable 32.

That is, when the cellular phone 10 is placed in the phone receiving part 22 of the main body 21, and the charging jack 33 is connected to the charger contact terminal 26a , the charging operation is executed. During such a charging operation, the charging state of the charger part 20 or the cellular phone 10 are displayed by the LED 27.

In a detailed description, when the charging operation is in progress, the LED 27 is turned on. Conversely, when the charging operation has been completed, the LED 27 is tuned off Thus, the charging state determines whether the LED 27 is turned on or off Preferably, a multicolor LED having three or seven colors is adapted to this invention so as to display various colors according to several conditions. The color of the multicolor LED helps a user to distinguish which device is being charged.

For example, when the charger part 20 of the cellular phone holder is being charged, the LED 27 emits red light Meanwhile, when the cellular phone 10 is being charged, the LED 27 emits yellow light.

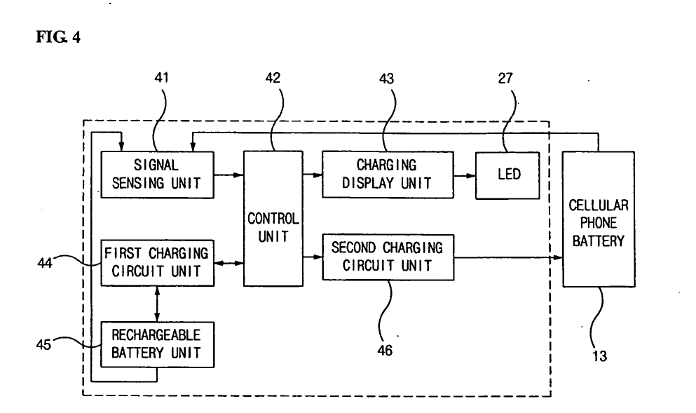

FIG. 4 is a block diagram to schematically show an internal construction of the charger part included m the portable cellular phone holder according to the present invention.

Referring to FIG. 4, a signal sensing unit 41 and a control unit 42 are provided in the charger part 20. The signal sensing unit 41 senses voltage or current which is output from a rechargeable battery unit 45 provided in the charger part 20 or the battery 13 of the cellular phone 10. The control unit 42 determines which device is charged and whether the charging operation has been completed or not, using a signal input from the signal sensing unit 41.

Further, a charging display unit 43, a first charging circuit unit 44, and a second charging circuit unit 46 are provided in the charger part 20. The charging display unit 43 functions to display a charging state, in response to an output signal of the control unit 42. The first charging circuit unit 44 functions to charge the rechargeable battery unit 45, using electricity fed from an external power source to the first charging circuit unit 44. The second charging circuit unit 46 serves to charge the battery 13 of the cellular phone, using electricity fed from the rechargeable battery unit 45.

Preferably, the signal sensing unit 41 further includes a sensing means (not shown) to sense the resistance of the rechargeable battery unit 45 and the battery 13, an A/D converter (not shown) to convert an analogue signal into a digital signal, and a signal amplification means (not shown).

Thus, when the charger part 20 of the cellular phone holder is charged, the signal sensing unit 41 senses the resistance of the rechargeable battery unit 45 provided in the charger part 20, and then converts the sensed resistance into a digital signal and amplifies the digital signal, prior to outputting the amplified signal to the control unit 42.

Next, the control unit 42 checks the connection of the main body 21 of the cellular phone holder to the charging element and the charging progress, and controls the charging display unit 43 to turn on or off the LED 27 according to the charging state.

For example, the control unit 42 controls the charging display unit 43 so that the LED 27 is turned on and emits red light when the charging operation is in progress, and the LED 27 is turned off when the charging operation has been completed.

Meanwhile, when the battery 13 of the cellular phone 10 is charged while the cellular phone 10 is received in the cellular phone holder, the signal sensing unit 41 senses the resistance of the cellular phone battery 13, and then converts the sensed resistance into a digital signal and amplifies the digital signal. Thereafter, the signal is output to the control unit 42.

At this time, the control unit 42 checks the connection of the battery 13 to the charging element and the charging progress, and controls the charging display unit 43 to turn on or off the LED 27 according to the charging state.

For example, the control unit 42 controls the charging display unit 43 so that the LED 27 is turned on and emits yellow light when the charging operation is in progress, and the LED 27 is turned off when the charging operation has been completed.

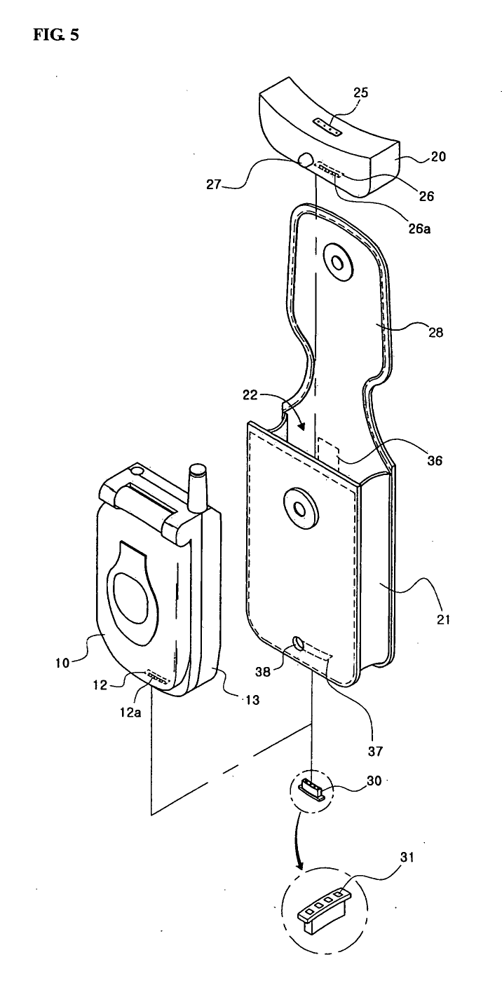

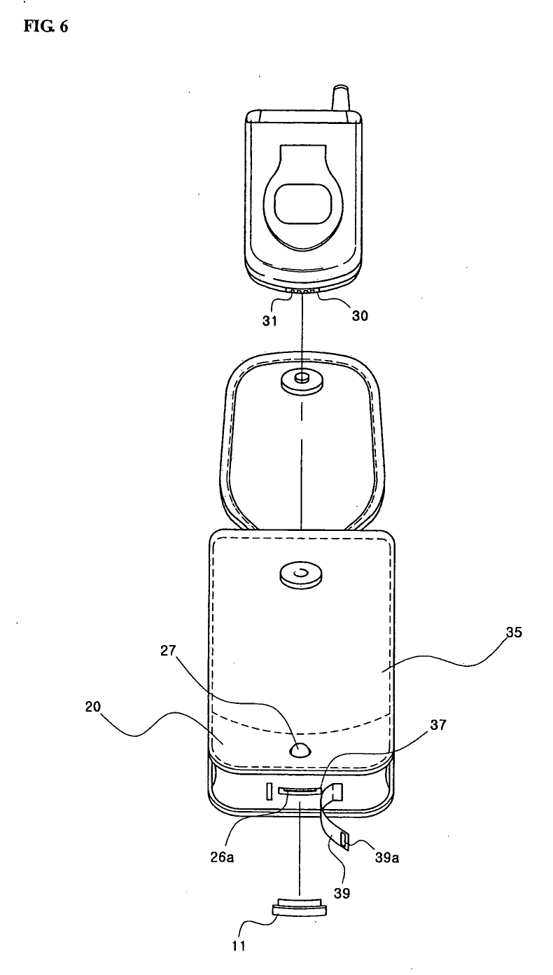

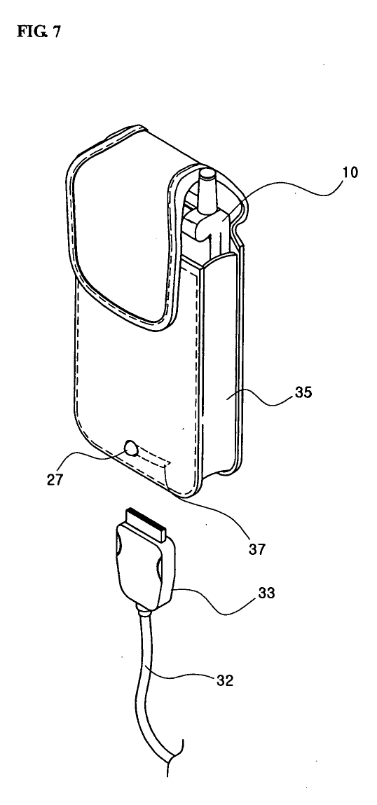

FIG. 5 is a perspective view to show the construction of a cellular phone holder having a case-type main body, according to the second embodiment of the present invention Further, FIG. 6 is a view to show a cellular phone which is charged using a previously charged charger part of FIG. 5, and FIG. 7 is a view to show the cellular phone and the charger part of FIG. 5, which are charged by an external charging cable.

Those elements common to both the first and second embodiments of the present invention will carry the same reference numerals.

Further, only the characteristics of the second embodiment which are different from those of the first embodiment will be described in detail herein.

Referring to FIGS. 5 to 7, the portable cellular phone holder according to the second embodiment includes a main body 21 to receive a cellular phone 10, a charger part 20 to charge the cellular phone 10 received in the main body 21, and a terminal cap 30 which electrically connects the cellular phone 10 to the charger part 20 to charge the cellular phone 10.

The main body 21 has the shape of a case which is made of cloth or fabric. A cover 28 is provided at an upper position of the main body 21 to cover the cellular phone 10 which is received in the main body 21.

Further, a band 36 is provided on a rear surface of the main body 21 to be fastened to a belt or the like, thus allowing a user to easily carry the cellular phone holder.

Unlike the first embodiment, the charger part 20 is separated from the main body 21 and received in the main body 21.

An opening 37 is provided on a lower surface of the main body 21 at a position corresponding to a recess 26 of the charger part 20 to allow the terminal cap 30 or a charging jack 33 to easily access the charger part 20. In this case, the opening 37 is slightly larger than the recess 23.

Further, a cover sheet 39 may be provided on the exterior of the lower surface of the main body 21 to protect the terminal cap 30, thus preventing the loss of the terminal cap 30 or preventing the terminal cap 30, fitted into the recess 26 of the charger part 20 though the opening 37, from being exposed to the outside.

Preferably, a fastening means, such as a Velcro fastener 39a , is attached to an inner surface of an end of the cover sheet 39 and an outer surface of the main body 21 corresponding to the inner surface of the cover sheet 39, thus allowing the cover sheet 39 to be easily attached to or detached from the main body 21.

Further, a hole 38 having a predetermined size is formed on a lower end of the front of the main body 21 to allow an LED 27 provided at a predetermined position on the charger part 20 to be exposed to the outside.

Since the operational effects of the second embodiment having such a construction are equal to those of the first embodiment, they will not be described herein.

The adaptation of the portable cellular phone holder according to the first and second embodiments of this invention will not be limited to a folding-type cellular phone. The portable cellular phone holder may be applied to various cellular phones including a bar-type cellular phone, a flip-type cellular phone, etc.

Moreover, the portable cellular phone holder may be applied to various portable equipment, such as an MP3 player or a personal digital assistant (PDA), in addition to the above-mentioned cellular phones.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present invention achieves the following effects.

First, a cellular phone can be charged while being carried by a user. Thus, even when making a long call while being out or when making a long trip, call interruption caused by the exhaustion of a battery is prevented.

Second, the present invention is provided with a terminal cap to electrically connect a contact terminal of the cellular phone to a charging terminal of a cellular phone holder, thus allowing the cellular phone to be simply charged merely by detaching and attaching the terminal cap.

Third, a charger contact terminal is provided at a predetermined position on a charger part so that an external charging jack is connected to the charger contact terminal, thus allowing the charger and the cellular phone to be charged by an vernal power source.

Fourth, the terminal cap is selectively fitted into the phone contact terminal or the charger contact terminal, thus being easily attached to and detached from the cellular phone holder or the cellular phone according to the charging state of the cellular phone.

Fifth, the cellular phone holder is provided with a closure cap to cover the phone contact terminal or the charger contact terminal, so that the closure cap in place of the terminal cap is fitted into the phone contact terminal when the cellular phone is not charged. On the contrary, the closure cap in place of the terminal cap is fitted into the charger contact terminal when the cellular phone is charged.

Sixth, a main body of the cellular phone holder is integrated with the charger part to form a panel-type structure, so that the attachment and detachment of the cellular phone is easy, and the overall construction of the cellular phone holder is very sample.

Seventh, unlike the above-mentioned construction, the main body of the cellular phone holder is fabricated in the form of a case. In this case, the charger part is separate from the main body and is detachably mounted to the main body. Such a construction allows the charger part to be charged alone by separating the charger part from the main body. Further, when the charger part is broken or damaged, a user has only to replace the charger part with a new one without the necessity of replacing the holder with a new one.

Eighth, an opening is formed on a lower surface of the main body at a position corresponding to the charger contact terminal, thus allowing the terminal cap or the closure cap to easily access the charger contact terminal, and allowing the external charging jack to be easily connected to the charger contact terminal.

Ninth, a cover sheet is provided on the main body of the cellular phone holder to open or close the opening of the main body, thus preventing the cap contact terminal from being exposed to the outside while the terminal cap is fitted into the charger contact terminal therefore preventing the cap contact terminal from being broken or damaged, and preventing the charger part from being broken due to contact with external metal material.

Tenth, a light emitting means, namely, an LED, is provided in the cellular phone holder, thus allowing the user to =fly confirm the charging state of the cellular phone or the charger part.

1. A portable cellular phone holder having an electric charging function, comprising:
a main body to receive a cellular phone having a phone contact terminal;
a charger part provided at a predetermined position of the main body and having a charging terminal; and
a terminal cap having a cap contact terminal which electrically connects the phone contact terminal to the charging terminal.

2. The portable cellular phone holder having the electric charging function according to claim 1, wherein the charger part comprises a charger contact terminal to be connected to an external charging jack.

3. The portable cellular phone holder having the electric charging function according to claim 2, wherein the terminal cap is selectively fitted into and connected to the phone contact terminal or the charger contact terminal.

4. The portable cellular phone holder having the electric charging function according to claim 3, further comprising:
a closure cap to selectively cover the phone contact terminal or the charger contact terminal.

5. The portable cellular phone holder having the electric charging function according to claim 3, wherein the main body comprises a panel-type structure to support the cellular phone, and the charger part is integrated with the main body in a single structure.

6. The portable cellular phone holder having the electric charging function according to claim 3, wherein the main body comprises a case-type structure to receive the cellular phone and the charger part therein, with an opening formed on the main body at a position corresponding to the charger contact terminal.

7. The portable cellular phone holder having the electric charging function according to claim 6, wherein the main body comprises a cover sheet to open or close the opening.

8. The portable cellular phone holder having the electric charging function according to claim 4, further comprising:
an LED to display a charging state of the cellular phone.

9. The portable cellular phone holder having the electric charging function according to claim 4, wherein the main body comprises a panel-type structure to support the cellular phone, and the charger part is integrated with the main body in a single structure.

10. The portable cellular phone holder having the electric charging function according to claim 4, wherein the main body comprises a case-type structure to receive the cellular phone and the charger part therein, with an opening formed on the main body at a position corresponding to the charger contact terminal.

11. The portable cellular phone holder having the electric charging function according to claim 10, wherein the main body comprises a cover sheet to open or close the opening.
